(19) United States
(12) Patent Application Publication
(10) Pub. No.: US 2019/0232546 A1
(43) Pub. Date: Aug. 1, 2019

(54) SHAPED TILE AND ITS MANUFACTURING METHOD FOR FABRICATING THE SAME

(71) Applicant: Dongguan Mei Jer Plastic Products Co., Ltd., Dongguan City (CN)

(72) Inventor: Pen-Yuan CHEN, New Taipei City (TW)

(21) Appl. No.: 15/918,926

(22) Filed: Mar. 12, 2018

(30) Foreign Application Priority Data
Jan. 26, 2018 (CN) 201810076300.6

(51) Int. Cl. B29C 51/30; B29C 51/14; B29C 51/20; B29C 51/26

(52) U.S. Cl. CPC B29C 51/306; B29C 51/14; B29C 2793/0009; B29C 51/264; B29C 51/20

(57) ABSTRACT

A shaped tile and its manufacturing method are described. The manufacturing method for fabricating a shaped tile comprises a thermoforming process, which comprises using a thermoforming mold to perform heat-compression on an intermediate tile so as to melt and deform the intermediate tile while heat-compression is applied, and to form a molding edge on at least one periphery of the intermediate tile such that the intermediate tile is turned into a shaped tile. By employing the proposed present invention, it is advantages of maintaining a final configuration of the shaped tile without getting any distortion.

This application claims priority for China patent application no. 201810076300.6 filed on Jan. 26, 2018, the content of which is incorporated by reference in its entirety.

### BACKGROUND OF THE INVENTION

### Field of the Invention

The present invention relates to a manufacturing method for fabricating a shaped tile, and more particularly to a manufacturing method in which an intermediate tile is being performed by heat compression in a thermoforming mold to turn the intermediate tile into a shaped tile, and to the shaped tile made by employing the manufacturing method.

### Description of the Prior Art

Typically, tiles are commonly used materials for paving floor tiles in order to provide flatness, durability and artistic vision of an environment. Regarding paving the floor tiles in recent technology, tiles with specific sizes for example, squares or rectangle, are usually arranged in a matrix array. Apart from these, tiles with other sizes for example, geometrical shapes can also be utilized for paving a non-matrix array floor.

In a conventional manufacturing method for fabricating a tile, at least one PU layer, grinding layer, printing layer, middle layer and bottom layer are laminated first, and a stamping press is then adopted to cut the tiles into pieces. Using such a conventional manufacturing method, the fringe of the tiles always shows a right angle and the ground will look tidy and flat when all these tiles with right angles are used for paving the floor tiles.

In order to improve the abovementioned manufacturing method, an improved method was proposed, which employs a stamping press to stamp and punch the tiles so as to form a shaped rim on every edge of the tiles as shown in FIG. 6. However, it shall be highly noticed that since no other forming method was involved except the stamping press, the shaped rim which has been formed will eventually get back to its original state (before being formed) as time goes by. Moreover, a final shape of the tile's rim is very difficult to control because how accurate the shaped rim of the tiles can be formed always ranges from the thickness of the grinding layer as well as the numbers of the scratch-resistant strips. Overall, the above mentioned manufacturing method has at least following disadvantages: 1. as time goes by, a shaped rim which has been formed by a stamping press will eventually return to its original state (before being formed), and thus a final shape cannot be maintained and always becomes blurred in the end. As shown in FIG. 6, the more the scratch-resistant strips and the grinding layers there are, the more easily and quickly the tile returns to its original state. 2. For not to destroy the grinding layer and affect its durability, a stamping press cannot be adopted when the grinding layer is too thin. 3. When merely using a stamping press, the shapes being formed are much more simple and monotonous, thus lacking sufficient variety, for example, irregular patterns cannot be made. 4. If the grinding layer is destroyed because of the stamping press, dust and stains may easily get stuck into fractures of the tiles in practical daily use.

A Taiwanese patent, 1274656 discloses a process of successively manufacturing a plastic tile, which comprises steps of preparing a raw material, using the raw material to fabricate a semi product of the plastic tile, cutting and making shaped rims of the semi product of the plastic tile so as to form a final product of the plastic tile. By such steps, the semi product of the plastic tile is cut and meanwhile extruded so as to form a plurality of inclinations. Therefore, the semi product of the plastic tile is turned into a final product of the plastic tile in which its frame is equipped with the plurality of inclinations. Besides, a mold can be utilized to cut and meanwhile to fabricate shaped rims of the plastic tile.

Therefore, on account of above, to overcome the abovementioned problem, it should be obvious that there is indeed an urgent need for the professionals in the field for a new manufacturing method for fabricating a shaped tile to be developed that can effectively solve those above mentioned problem occurring in the prior design.

### SUMMARY OF THE INVENTION

In order to overcome the abovementioned disadvantages that a final configuration of the tile's shaped rim is barely maintained, the present invention is provided for a novel shaped tile and its manufacturing method for fabricating the same.

One major objective in accordance with the present invention is provided for a manufacturing method for fabricating a shaped tile. The proposed manufacturing method for fabricating a shaped tile mainly uses a thermoforming mold to perform heat-compression on an intermediate tile. Since the thermoforming mold comprises a specific forming area, a plurality of molding edge can be formed on every periphery of the intermediate tile which has been through the heat-compression treatment. Moreover, the formed molding edges will not get distortion as time passes by. As a result, by such a proposed manufacturing method for fabricating a shaped tile, shaped tiles with high quality and excellent consistency can be accomplished.

For achieving the abovementioned objectives, the present invention provides a manufacturing method for fabricating a shaped tile, comprising a thermoforming process, which comprises using a thermoforming mold to perform heat-compression on an intermediate tile, wherein the thermoforming mold comprises at least one forming area so as to melt and deform the intermediate tile while heat-compression is applied, and to form a molding edge on at least one periphery of the intermediate tile such that the intermediate tile is turned into a shaped tile.

In one embodiment, before the thermoforming process, the proposed manufacturing method for fabricating a shaped tile further comprises a material providing process, comprising providing a rooting material, wherein a printing layer and a grinding layer are further disposed upon the rooting material in sequence; a hydraulic process, for oil-pressing the rooting material, the printing layer and the grinding layer so as to form a hybrid planking tile; and a stamping process, for stamping and punching the hybrid planking tile so as to form the intermediate tile.

According to one embodiment of the present invention, the thermoforming process is applied for only melting and deforming the intermediate tile.

According to one embodiment of the present invention, the proposed manufacturing method for fabricating a shaped tile further comprises a waiting process after the hydraulic process, and the waiting process comprises stilling the hybrid planking tile at a constant temperature for a first certain time period.

In one embodiment, the first certain time period in the waiting process is at least 24 hours. For example, the first certain time period in the waiting process is 24-48 hours.

Moreover, according to one embodiment of the present invention, a temperature when performing the heat compression in the thermoforming process is 30-80° C. For example, in a preferable embodiment, the temperature when performing the heat compression in the thermoforming process is 40-60° C.

In addition, the proposed manufacturing method for fabricating a shaped tile further comprises a cooling process after the thermoforming process, and the cooling process comprises cooling the shaped tile at a room temperature for a second certain time period.

In one embodiment, the second certain time period in the cooling process is at least 20 minutes. For example, the second certain time period in the cooling process is 20-50 minutes.

Moreover, according to one embodiment of the present invention, a pressure utilized when applying the thermoforming process is controlled to be at least 40 kg/m². Preferably, the pressure is controlled to be in a range of 40-130 kg/m².

Furthermore, the abovementioned thermoforming mold may further comprise a plurality of surface so as to perform the heat-compression on a plurality of the intermediate tile at one time.

According to one embodiment of the present invention, a cross sectional contour of the molding edge of the shaped tile may comprise a bevel edge, a round edge or any other irregular edge, or the molding edge of the shaped tile may comprise irregular and/or certain patterns which are successively disposed along the at least one periphery of the shaped tile.

As a result, by employing the abovementioned techniques, the proposed manufacturing method for fabricating a shaped tile of the present invention employs a thermoforming step as well as a thermoforming mold to form at least one molding edge on at least one periphery of the intermediate tile such that the intermediate tile is turned into a shaped tile. Since the thermoforming mold of the present invention is specifically designed to perform the thermoforming process in which its pressure and temperature when the heat compression is applied can be controlled respectively, the molding edge on the intermediate tile can be effectively and successfully designed without destroying the inner material of the intermediate tile. Moreover, the thermoforming process of the present invention can be utilized for preventing the formed molding edge from accidentally reversing back to its original state. As such, by employing the proposed processes, a consistency of all the shaped tiles can be accomplished, thereby making an extremely high quality of the shaped tiles of the present invention.

On the other hand, in another aspect of the present invention, the present invention discloses a shaped tile made by employing the above mentioned manufacturing method for fabricating the shaped tile. The shaped tile comprises a tile body including an upper plane and a plurality of upper corner being configured on the upper plane, and the molding edge is formed on at least one of the plurality of the upper corner.

In a preferable embodiment, all the upper corners are formed with the molding edge.

A cross sectional contour of the molding edge of the shaped tile may comprise a bevel edge, a round edge or any other irregular edge, or the molding edge of the shaped tile may comprise irregular and/or certain patterns which are successively disposed along the at least one periphery of the shaped tile.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a cross sectional view of a shaped tile in accordance with one embodiment of the present invention.

FIG. 2 shows a cross sectional view of a shaped tile in together with a thermoforming mold in accordance with one embodiment of the present invention.

FIG. 3 shows an upward view of a thermoforming mold in accordance with one embodiment of the present invention.

FIG. 4 shows a flow chart of a manufacturing method for fabricating a shaped tile in accordance with one embodiment of the present invention.

FIG. 5 shows an actual view of a shaped tile in accordance with one embodiment of the present invention.

FIG. 6 shows an actual view of a conventional tile with shaped rims in the prior art.

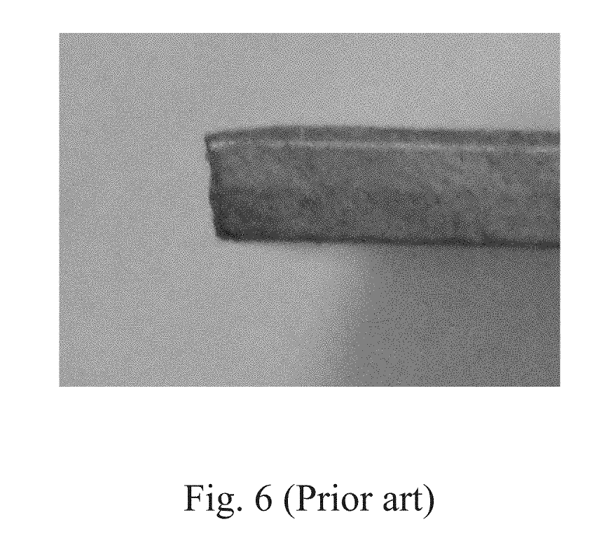

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

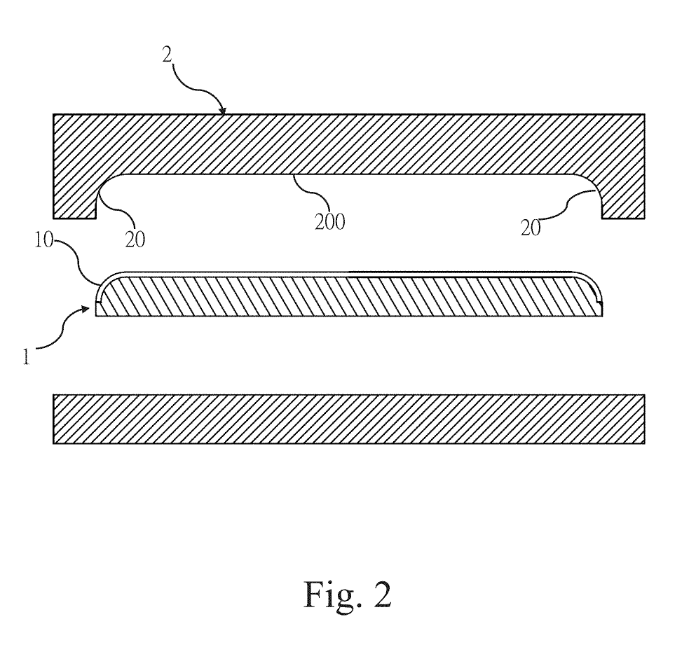

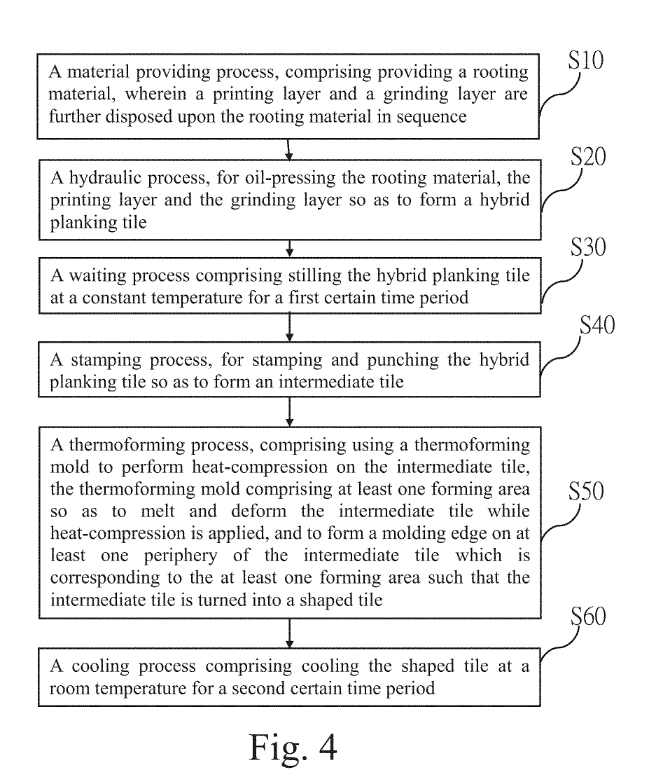

Please refer to FIG. 2 and FIG. 4. The manufacturing method for fabricating a shaped tile of the present invention comprises steps of a material providing process S10, a hydraulic process S20, a waiting process S30, a stamping process S40, a thermoforming process S50 and a cooling process S60.

The material providing process S10 comprises providing a rooting material, wherein a printing layer and a grinding layer are further disposed upon the rooting material in sequence. The rooting material may comprise PolyVinyl Chloride (PVC), and by stirring the at least one raw material, the rooting material is formed.

The hydraulic process S20 comprises using a hydraulic machinery for oil-pressing the rooting material, the printing layer and the grinding layer so as to form a hybrid planking tile.

The waiting process S30 comprises stilling the hybrid planking tile at a constant temperature for a first certain time period. For example, the first certain time period in the waiting process S30 may be at least 24 hours. Preferably, the first certain time period in the waiting process S30 can be 24-48 hours.

The stamping process S40 comprises using a stamping press to stamp and punch the hybrid planking tile so as to form an intermediate tile.

The thermoforming process S50 comprises using a thermoforming mold 2 to perform heat-compression on the intermediate tile, wherein a surface 200 of the thermoforming mold 2 comprises at least one forming area 20 so as to melt and deform the intermediate tile while heat-compression is applied, and to form a molding edge on at least one periphery of the intermediate tile such that the intermediate tile is turned into a shaped tile 1. According to one embodiment of the present invention, a molding edge comprises for instance, a bevel edge, a round edge or any other irregular edge as long as its cross sectional contour is not right angle. Alternatively, the molding edge can further comprise irregular and/or certain patterns which are successively disposed along the at least one periphery of the shaped tile. Please refer to FIG. 2. For example, the cross sectional contour of the molding edge in the shaped tile 1 is a round edge. And the abovementioned certain patterns comprise patterns composed of cartoons, artistries, geometries, nature-mimic drafts and so on.

Furthermore, the thermoforming process S50 is applied for only melting and deforming the intermediate tile, but not destroying it. According to the embodiment of the present invention, the temperature when performing the heat compression on the intermediate tile is set to be in a range of 30-80° C. Compared to the prior art in which temperatures high than 100° C. are commonly used, the temperature of the present invention is much lowered, thereby making very little (almost no) destruction to the intermediate tile. In addition, a pressure utilized when applying the thermoforming process S50 is controlled to be at least 40 kg/m². Preferably, the pressure utilized when applying the thermoforming process S50 can be set in a range of 40-130 kg/m². In such a preferable embodiment, the temperature when performing the heat compression on the intermediate tile is 40-60° C.

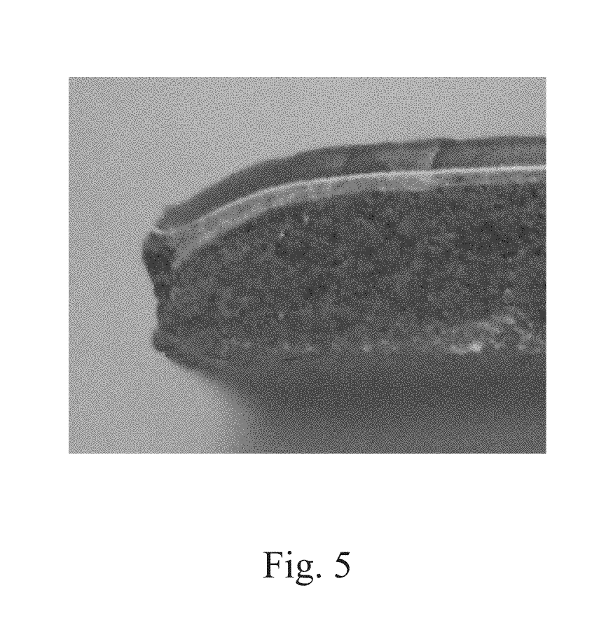

Please refer to FIG. 5, which shows an actual view of the shaped tile 1 according to one embodiment of the present invention. As shown in FIG. 5, it is apparent that the cross sectional contour of the molding edge in the shaped tile 1 is a round edge. With respect to the prior art, the round edge of the present invention is much more art-curved and delicate in outline.

Moreover, according to the embodiment of the present invention, the shape of the molding edge in the shaped tile 1 can be determined by a variety of forming areas which are configured on the surface 200 of the thermoforming mold 2. For example, the molding edge in one embodiment may comprise a bevel edge, a round edge or any other irregular edge as long as its cross sectional contour is not right angle. Alternatively, the molding edge in other embodiments may further comprise irregular and/or certain patterns which are successively disposed along the at least one periphery of the shaped tile and composed of cartoons, artistries, geometries, nature-mimic drafts and so on.

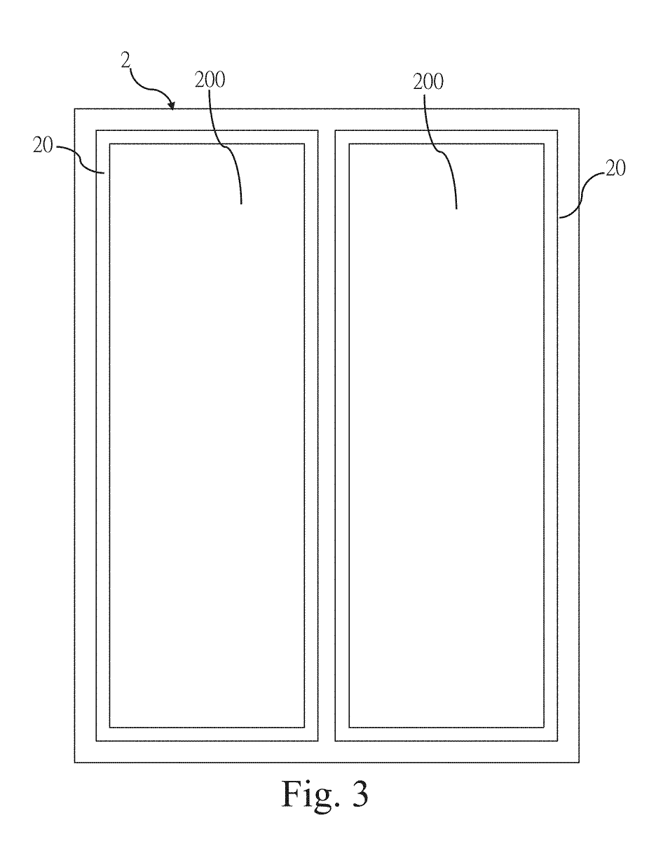

Please refer to FIG. 3, which shows an upward view of the thermoforming mold 2 according to one embodiment of the present invention. As shown in FIG. 3, it is obvious that the thermoforming mold 2 may further comprise a plurality of surface 2 so as to perform heat-compression on multiple intermediate tiles at one time.

The cooling process S60 of the present invention comprises cooling the shaped tile 1 at a room temperature for a second certain time period. For example, the second certain time period in the cooling process S60 may be at least 20 minutes. Preferably, the second certain time period in the cooling process S60 can be 20-50 minutes.

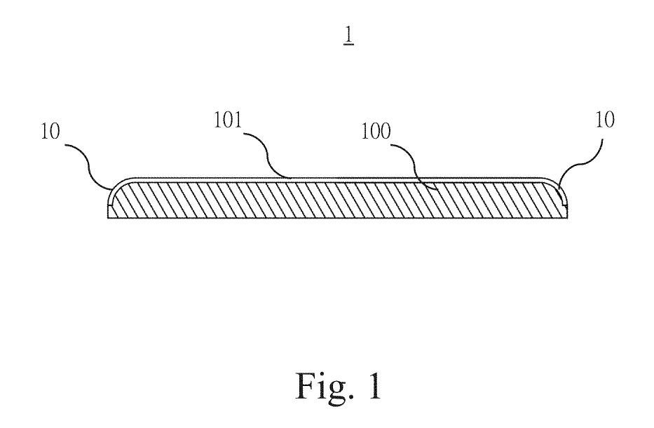

Please refer to FIG. 1, which shows a cross sectional view of the shaped tile 1 made by employing the abovementioned manufacturing method for fabricating a shaped tile according to one embodiment of the present invention. The proposed shaped tile 1 comprises a tile body 100, including an upper plane 101 and a plurality of upper corner 10 being configured on the upper plane 101. The proposed molding edge is formed on at least one upper corner 10. In a preferable embodiment, the proposed molding edges are formed on all the upper corners 10 of the tile body 100. For example, a shape of the tile body 100 can be triangle, rectangle or polygon. Similarly, the proposed molding edge of the shaped tile 1 according to one embodiment may comprise a bevel edge, a round edge or any other irregular edge as long as its cross sectional contour is not right angle. Alternatively, the molding edge in other embodiments may further comprise irregular and/or certain patterns which are successively disposed along the at least one periphery of the shaped tile and composed of cartoons, artistries, geometries, nature-mimic drafts and so on.

As a result, to sum up, the present invention certainly provides a novel and inventive manufacturing method for fabricating a shaped tile which has never been seen or proposed ever before. The proposed invention employs a thermoforming mold 2 to form at least one molding edge on at least one periphery of the intermediate tile such that the intermediate tile is turned into a shaped tile 1. Since the thermoforming mold 2 is specifically employed to perform the thermoforming process S50 in which its pressure and temperature when the heat compression is applied can be controlled respectively, the molding edge on the intermediate tile can be effectively and successfully designed without destroying the inner material of the intermediate tile. Moreover, the thermoforming process S50 can be utilized for preventing the formed molding edge from accidentally reversing back to its original state. By such processes, a consistency of all the shaped tiles 1 can be accomplished, thereby making an extremely high quality of the shaped tiles 1 of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A manufacturing method for fabricating a shaped tile, comprising:
a thermoforming process, which comprises using a thermoforming mold to perform heat-compression on an intermediate tile, wherein the thermoforming mold comprises at least one forming area so as to melt and deform the intermediate tile while heat-compression is applied, and to form a molding edge on at least one periphery of the intermediate tile which is corresponding to the at least one forming area such that the intermediate tile is turned into a shaped tile.

2. The manufacturing method for fabricating a shaped tile according to claim 1, before the thermoforming process, further comprising:
a material providing process, comprising providing a rooting material, wherein a printing layer and a grinding layer are further disposed upon the rooting material in sequence;
a hydraulic process, for oil-pressing the rooting material, the printing layer and the grinding layer so as to form a hybrid planking tile; and
a stamping process, for stamping and punching the hybrid planking tile so as to form the intermediate tile.

3. The manufacturing method for fabricating a shaped tile according to claim 1, wherein the thermoforming process is applied for only melting and deforming the intermediate tile.

4. The manufacturing method for fabricating a shaped tile according to claim 2, further comprising a waiting process after the hydraulic process, the waiting process comprising stilling the hybrid planking tile at a constant temperature for a first certain time period.

5. The manufacturing method for fabricating a shaped tile according to claim 4, wherein the first certain time period in the waiting process is at least 24 hours.

6. The manufacturing method for fabricating a shaped tile according to claim 4, wherein the first certain time period in the waiting process is 24-48 hours.

7. The manufacturing method for fabricating a shaped tile according to claim 1, wherein a temperature when performing the heat compression in the thermoforming process is 30-80° C.

8. The manufacturing method for fabricating a shaped tile according to claim 7, wherein the temperature when performing the heat compression in the thermoforming process is 40-60° C.

9. The manufacturing method for fabricating a shaped tile according to claim 1, further comprising a cooling process after the thermoforming process, the cooling process comprising cooling the shaped tile at a room temperature for a second certain time period.

10. The manufacturing method for fabricating a shaped tile according to claim 9, wherein the second certain time period in the cooling process is at least 20 minutes.

11. The manufacturing method for fabricating a shaped tile according to claim 9, wherein the second certain time period in the cooling process is 20-50 minutes.

12. The manufacturing method for fabricating a shaped tile according to claim 1, wherein a pressure utilized when applying the thermoforming process is controlled to be at least 40 kg/m².

13. The manufacturing method for fabricating a shaped tile according to claim 1, wherein a pressure utilized when applying the thermoforming process is controlled to be 40-130 kg/m².

14. The manufacturing method for fabricating a shaped tile according to claim 1, wherein the thermoforming mold further comprises a plurality of surface so as to perform the heat-compression on a plurality of the intermediate tile at one time.

15. The manufacturing method for fabricating a shaped tile according to claim 1, wherein a cross sectional contour of the molding edge of the shaped tile comprises a bevel edge, a round edge or any other irregular edge, or the molding edge of the shaped tile comprises irregular and/or certain patterns which are successively disposed along the at least one periphery of the shaped tile.

16. A shaped tile made by employing the manufacturing method for fabricating the shaped tile according to claim 1, comprising a tile body including an upper plane and a plurality of upper corner being configured on the upper plane, wherein the molding edge is formed on at least one of the plurality of the upper corner.

17. The shaped tile made by employing the manufacturing method for fabricating the shaped tile according to claim 16, wherein a plurality of the molding edge is formed on all the upper corners.

18. The shaped tile made by employing the manufacturing method for fabricating the shaped tile according to claim 16, wherein a cross sectional contour of the molding edge of the shaped tile comprises a bevel edge, a round edge or any other irregular edge, or the molding edge of the shaped tile comprises irregular and/or certain patterns which are successively disposed along the at least one periphery of the shaped tile.
